(19) United States
(12) Patent Application Publication
(10) Pub. No.: US 2012/0098414 A1
(43) Pub. Date: Apr. 26, 2012

(54) FLAT PANEL DISPLAY, INTERMEDIATE MANUFACTURED PRODUCT AND METHOD OF MANUFACTURING SAME

(75) Inventor: Hideyo Nakamura, Kawasaki-shi (JP)

(73) Assignee: FUJI ELECTRIC CO., LTD., Kawasaki-shi (JP)

(21) Appl. No.: 12/998,619

(22) PCT Filed: Jun. 23, 2009
(86) PCT No.: PCT/JP2009/061392

§ 371 Date: Jul. 29, 2011

(51) Int. Cl. H05B 33/14; H01J 9/00; G02B 5/22; H01J 5/16

(52) U.S. Cl. 313/504; 313/112; 445/24; 359/891

(57) ABSTRACT

The present invention aims at providing a structure, manufacturing method, and an intermediate manufactured product enabling the low-cost manufacture of a flat panel display with high fineness. In a flat panel display of the invention, by decentering the opening portions formed by a bank in red and green subpixels to the blue subpixel side, color conversion layers with higher fineness can be formed even when using conventional apparatuses and materials. Moreover, decentering of the opening portions of the bank enables reductions in manufacturing time and manufacturing cost.

### TECHNICAL FIELD

The present invention relates principally to a flat panel display, an intermediate manufactured product thereof, and a method of manufacturing same. More specifically, the present invention relates to an organic EL display, an intermediate manufactured product thereof, and a method of manufacturing same.

### BACKGROUND ART

In a representative configuration of the panel unit of an organic EL display with a top-emission structure, an organic EL emission substrate (TFT substrate) and a color filter substrate are bonded together.

An organic EL substrate known in the prior art includes a supporting substrate; a plurality of switching elements (TFTs or similar), existing at positions forming a plurality of subpixels; a planarization resin layer, covering the switching elements, and planarizing the upper face thereof; a reflective electrode, comprising a plurality of partial electrodes, connected to the switching elements via contact holes provided in the planarization resin layer; an insulating layer, providing insulation between the plurality of partial electrodes forming the reflective electrode, and delimiting a plurality of emission portions; an organic EL layer, formed at least over the reflective electrode; a transparent electrode, formed integrally over the organic EL layer; and similar. It is preferable that the transparent electrode be connected, in the peripheral portion of the organic EL substrate, to substrate wiring provided on the supporting substrate. The substrate wiring can include control signal lines for switching elements (TFT gate control lines and data control lines), power supply lines, and similar. Further, the organic EL substrate may include a control IC to control the above-described control signal lines, an FPC mounting terminal for connection to an external circuit, and similar. Further, a barrier layer covering the layers below the transparent electrode can be provided.

On the other hand, a color filter substrate includes, at least, a transparent substrate, and a color filter provided corresponding to the emission portions of the organic EL substrate. A color filter substrate may include a black matrix, as necessary, in order to improve the contrast ratio. Further, as has been proposed in, for example, Japanese Patent Application Laid-open No. 2007-157550, a color filter substrate may be a color conversion filter substrate, including a color conversion layer to convert the hue of light emitted by an organic EL substrate into a desired hue (see Patent Reference 1). As methods of formation of color filters and color conversion layers, in addition to photolithography methods which have conventionally been used, inkjet methods and other application methods are also coming into widespread use. When using an inkjet method to form a plurality of types of color filters or a plurality of types of color conversion layers, generally a bank is provided, to prevent mixing of a plurality of types of inks (so-called “color mixing”) in positions not targeted for formation. Further, inkjet methods have also been studied as means of forming the organic EL layers of organic EL substrates.

FIG. 1A and FIG. 1B show one example of a color conversion filter substrate of the prior art. The color filter substrate includes a transparent substrate 510, a mesh-shape black matrix 520 having a plurality of opening portions, red (R), green (G) and blue (B) color filters 530(R,G,B) formed from a plurality of stripe-shape portions, a bank 550 comprising a plurality of stripe-shape portions, and a red color conversion layer 540R and green color conversion layer 540G comprising a plurality of stripe-shape portions which are formed in spaces in the bank 550. In this example, a color conversion filter substrate is illustrated in which two types of color conversion layers 540, red and green, are formed.

FIG. 2A and FIG. 2B show another example of a color conversion filter substrate of the prior art. The color filter substrate shown in FIG. 2A and FIG. 2B differs from the color conversion filter substrate shown in FIG. 1A and FIG. 1B in that the bank 550 has a mesh shape having a plurality of opening portions, and in that the red color conversion layer 540R and green color conversion layer 540G are formed within opening portions of the bank 550, and are formed from a plurality of rectangle-shape portions.

Finally, while positioning the emission portions on the side of the organic EL substrate and the color filter on the side of the color filter substrate (or color conversion filter substrate), the organic EL substrate and the color filter substrate are bonded together, to form the panel unit of an organic EL display. During bonding, generally a gap layer is provided between the organic EL substrate and the color filter substrate. A gap layer is generally formed using an adhesive or other solid filler material. However, a gap layer may also be formed using a liquid filler material or a gas filler material. When precise control of the distance between the organic EL substrate and the color filter substrate is desired, spacers may be provided on the color filter 530 or on the bank 550. By providing spacers, the occurrence of crosstalk due to too large a distance between the two substrates, as well as the effects of interference due to too small a distance between the two substrates, and damage to emission portions due to mechanical contact with the constituent layers of the organic EL substrate, and similar can be prevented. Further, the occurrence of unevenness in spreading of the filler material when forming a gap layer using a solid or a liquid filler material can also be prevented by the installation of spacers.

Japanese Patent Application Laid-open No. 2005-353258 discloses a method in which, when using an inkjet method to form an organic EL layer in an organic EL substrate, and a bank has a layered structure of an inorganic bank layer and an organic bank layer, the opening portions of the inorganic bank layer are decentered toward the substrate inner side from the opening portions of the organic bank layer in the substrate peripheral portion (see Patent Reference 2). An object of the above-described opening portion decentering is to address the irregularity in film thickness of the organic EL layer due to the difference in volatilization rate of the solvent on the substrate periphery side and on the substrate inner side. More specifically, an organic EL substrate with desired characteristics is provided, in which portions of the organic EL layer with other than a desired thickness are blocked by the inorganic bank layer, electrically and/or optically. Japanese Patent Application Laid-open No. 2005-353258 does not disclose or suggest improvement of fineness or improvement of productivity through decentering of the opening portions in the bank layer.
Patent Reference 1: Japanese Patent Application Laid-open No. 2007-157550
Patent Reference 2: Japanese Patent Application Laid-open No. 2005-353258

When manufacturing the color conversion filter substrates shown in FIG. 1A through FIG. 2B, the color conversion layer 540 is formed by a method which includes (a) a process of preparing a layered member, in which are formed, on a transparent substrate 510, a black matrix 520, a color filter 530, and a bank 550; (b) a process of using an inkjet method to cause ink, including a red or green color conversion material, to adhere onto a red or green color filter 530 of the layered member; and (c) a process of heating and drying the adhering ink liquid drops. Here, in order to form a color conversion layer 540 of a desired film thickness, the processes (a) through (c) may be repeated a plurality of times.

This method is explained in detail referring to FIG. 3A through FIG. 3C, taking as an example a green color conversion layer 540G. Ink liquid drops 570 dispensed from an inkjet apparatus or similar are spherical in shape during flight, as shown in FIG. 3A. And, as shown in FIG. 3A, the center C_{D} of an opening portion of the bank (the region from one bank side wall to another bank side wall) coincides with the center C_{BM} of the opening portion between the black matrixes. Next, when the ink liquid drop 570 makes impact on the green color filter 530G enclosed between the two banks 550, the adhering ink liquid drop 572 spreads over the region from the side wall of one bank 550 to the other bank 550, and moreover bulges to a height exceeding the upper faces of the banks 550, as shown in FIG. 3B. Then, the adhering ink spreads within the green subpixel, and by heating to remove the solvent in the ink, a green color conversion layer 540G is formed, as shown in FIG. 3C.

When forming a color conversion layer 540 using an inkjet method as shown in FIG. 3A through FIG. 3C, there exist both limits to the reduction in size of the ink liquid drops 570 dispensed from the inkjet apparatus, and variation in the position of impact of the dispensed ink liquid drops 572. Further, with respect to the banks 550 also, for practical purposes there exist lower limits to the width and to the arrangement interval (that is, the fineness) of formation possible. Here, when the sum of the size of the dispensed ink liquid drops 570 and the variation in impact position of ink liquid drops 570 is larger than the bank arrangement interval, impact defects of the ink liquid drops 570 occur. In other words, the fineness limit of the color conversion layer 540 is determined depending on the physical properties of the material used and the apparatus. On the other hand, even when an inkjet apparatus can be used which can dispense sufficiently small liquid drops compared with banks 550 with a given fineness, and for which moreover there is little variation in impact position, if the size of the dispensed ink liquid drops 570 is too small, the number of application to obtain the required film thickness increases. As a result, manufacturing time increases, and the cost of forming the color conversion layer 540 rises. Hence ink liquid drops 570 must be used which are as large as possible within the range in which impact defects do not occur when forming the color conversion layer 540. The higher the fineness of the color conversion layer 540 (that is, the arrangement interval of the banks 550), the more serious these problems become.

### DISCLOSURE OF THE INVENTION

Hence an object of this invention is, when using an application method to form a color conversion layer or similar on a structure having a bank, to either raise the fineness while using a conventional material and apparatus, or to perform application in greater quantities at a specific fineness to shorten the manufacturing time, so that a high-fineness, low-cost organic EL display or other flat panel display is provided.

In order to resolve the above problems, in this invention a blue-light transmissive material is used, a bank is formed at the boundary between a red color subpixel and a green color subpixel and over the region in which light of a blue color subpixel is transmitted, and decentering, such that the center of a bank opening portion is shifted to the side of the blue color subpixel side with respect to the black matrix opening center or the insulating layer opening center, is allowed.

The flat panel display of a first embodiment of the invention has:

a color conversion filter substrate, including a transparent substrate, a black matrix which has a plurality of opening portions and which delimits red, green and blue subpixels, red and green color filters formed in the red and green subpixels, a bank, and a red color conversion layer and green color conversion layer formed in the red and green subpixels; and

an emission substrate having a plurality of emission portions,

the flat panel display being characterized in that

the bank is formed from a blue-light transmissive material which transmits at least blue light, and has opening portions in the red subpixels and green subpixels, and in every red and green subpixel on the flat panel display, the centers of opening portions of the bank are decentered to the blue subpixel side with respect to the centers of the opening portions of the black matrix. Here, it is desirable that the bank be formed on the black matrix positioned on a boundary of red subpixels and green subpixels, and on the blue subpixels. Further, the blue-light transmissive material forming the bank may be blue material which transmits only blue light. Also, a blue color filter may be further included in the blue subpixels. Further, the emission substrate may be an organic EL emission substrate.

The flat panel display of a second embodiment of the invention has:

an organic EL emission substrate, including a substrate, a reflective electrode, an insulating layer which has a plurality of opening portions, and which delimit red emission portions, green emission portions and blue emission portions, an organic EL layer, a transparent electrode, a bank, a red color conversion layer formed in positions corresponding to red subpixels, and a green color conversion layer formed in positions corresponding to green subpixels; and

a color filter substrate, including a transparent substrate, and red and green color filters,

the flat panel display being characterized in that

the bank is formed from a blue-light transmissive material which transmits at least blue light, and has opening portions in the red emission portions and green emission portions; and

every red emission portion and green emission portion on the flat panel display, the centers of opening portions of the bank are decentered to blue emission portions with respect to the centers of the opening portions of the insulating layer. Here, it is desirable that the bank be formed on a boundary of red emission portions and green emission portions, and on the blue emission portions. Further, the blue-light transmissive material forming the bank may be blue material which transmits only blue light. Further, the color filter substrate may further include a blue color filter.

The method of manufacturing a flat panel display of a third embodiment of the invention is characterized in having:

(1) a step of forming a color conversion filter substrate, which is a process including:
(a) a step of forming a black matrix having a plurality of opening portions on a transparent substrate, and delimiting red, green, and blue subpixels by the plurality of opening portions;
(b) a step of forming red and green color filters in the red and green subpixels respectively;
(c) a step of, in use of a blue-light transmissive material which transmits at least blue light, forming a bank having opening portions in the red subpixels and green subpixels, in which every red and green subpixel on the color conversion filter substrate, the centers of opening portions of the bank are decentered to a blue subpixel side with respect to the centers of the opening portions of the black matrix; and
(d) a step of, in use of an inkjet method, forming a red color conversion layer and a green color conversion layer in the red and green subpixels;

(2) a step of preparing an emission substrate having a plurality of emission portions; and,

(3) a step of bonding together the color conversion filter substrate and the emission substrate. Here, in the step (1)(c), it is desirable that the bank be formed on the black matrix positioned on the boundary of red subpixels and green subpixels, and on the blue subpixels. Further, the blue-light transmissive material forming the bank may be blue material which transmits only blue light. Also, a step (b′) of forming a blue color filter in the blue subpixels may be further included. Further, the emission substrate may be an organic EL emission substrate.

The method of manufacturing a flat panel display of a fourth embodiment of the invention is characterized in having:

(4) a step of forming an organic EL emission substrate, which is a step including:
(a) a step of forming a reflective electrode on a substrate;
(b) a step of forming an insulating layer having a plurality of opening portions, and delimiting red emission portions, green emission portions by the plurality of opening portions and blue emission portions;
(c) a step of forming an organic EL layer;
(d) a step of forming a transparent electrode;
(e) a step of, in use of a blue-light transmissive material which transmits at least blue light, forming a bank having opening portions in the red emission portions and green emission portions, in which every red and green emission portion on the organic EL emission substrate, the centers of opening portions of the bank are decentered to a blue emission portion side with respect to the centers of the opening portions of the insulating layer; and
(f) a step of, in use of an inkjet method, forming a red color conversion layer and a green color conversion layer in the red emission portions and in the green emission portions respectively;

(5) a step of forming red and green color filters on a transparent substrate, and forming a color filter substrate; and,

(6) a step of bonding together the organic EL emission substrate and the color filter substrate. Here, in process (4)(e), it is desirable that the bank be formed on a boundary of red emission portions and green emission portions, and on the blue emission portions. Further, the blue-light transmissive material forming the bank may be blue material which transmits only blue light. Also, in step (5), a step of forming a blue color filter on the transparent substrate may be further included.

The color conversion filter substrate of a fifth embodiment of the invention has:

a transparent substrate; a black matrix which has a plurality of opening portions, and which delimits red, green and blue subpixels, red and green color filters formed in the red and green subpixels; a bank; and a red color conversion layer and green color conversion layer formed in the red and green subpixels,

the color conversion filter substrate being characterized in that

the bank is formed from a blue-light transmissive material which transmits in least blue light, and has opening portions at the red subpixels and green subpixels; and

every red and green subpixel on the color conversion filter substrate, the centers of opening portions of the bank are decentered to the blue subpixel side with respect to the centers of the opening portions of the black matrix. Here, it is desirable that the bank be formed on the black matrix positioned on a boundary of red subpixels and green subpixels, and on the blue subpixels. Further, the blue-light transmissive material forming the bank may be blue material which transmits only blue light. Also, a blue color filter may be further included in the blue subpixels.

The organic EL emission substrate of a sixth embodiment of the invention has:

a substrate; a reflective electrode; an insulating layer which has a plurality of opening portions, and which delimit red emission portions, green emission portions and blue emission portions; an organic EL layer; a transparent electrode; a bank; a red color conversion layer, and a green color conversion layer,

the organic EL emission substrate being characterized in that

the bank is formed from a blue-light transmissive material which transmits at least blue light, and has opening portions in the red emission portions and green emission portions, and

in every red emission portion and green emission portion on the organic EL emission substrate, the centers of opening portions of the bank are decentered to a blue emission portion side with respect to the centers of the opening portions of the insulating layer. Here, it is desirable that the bank be formed on a boundary of red emission portions and green emission portions, and on the blue emission portions. Further, the blue-light transmissive material forming the bank may be blue material which transmits only blue light.

In a flat panel display in which a color conversion layer and similar are formed by an inkjet method, by adopting a bank structure of this invention, the bank opening width can be expanded compared with the prior art. By this means, fineness can be improved without changing the inkjet apparatus or material. Or, by increasing the diameter of ink liquid drops at the same fineness, the number of applications by the inkjet method can be reduced. Through the above advantageous results, a high-fineness flat panel display can be manufactured at low cost.

### BRIEF DESCRIPTION OF THE DRAWINGS

FIG. 1A is a plane view of one example of a color conversion filter substrate of the prior art;

FIG. 1B is a cross-sectional view along section line IB-IB of one example of a color conversion filter substrate of the prior art;

FIG. 2A is a plane view of another example of a color conversion filter substrate of the prior art;

FIG. 2B is a cross-sectional view along section line IIB-IIB of another example of a color conversion filter substrate of the prior art;

FIG. 3A is a cross-sectional view explaining formation of a color conversion layer in a color conversion filter substrate of the prior art;

FIG. 3B is a cross-sectional view explaining formation of a color conversion layer in a color conversion filter substrate of the prior art;

FIG. 3C is a cross-sectional view explaining formation of a color conversion layer in a color conversion filter substrate of the prior art;

FIG. 4A is a plane view of one example of a color conversion filter substrate used in an organic EL display of this invention;

FIG. 4B is a cross-sectional view along section line IVB-IVB of one example of a color conversion filter substrate used in an organic EL display of this invention;

FIG. 5A is a plane view of another example of a color conversion filter substrate used in an organic EL display of this invention;

FIG. 5B is a cross-sectional view along section line VB-VB of another example of a color conversion filter substrate used in an organic EL display of this invention;

FIG. 6A is a cross-sectional view explaining formation of a color conversion layer in a color conversion filter substrate of this invention;

FIG. 6B is a cross-sectional view explaining formation of a color conversion layer in a color conversion filter substrate of this invention;

FIG. 6C is a cross-sectional view explaining formation of a color conversion layer in a color conversion filter substrate of this invention;

FIG. 7 is a cross-sectional view showing one example of an organic EL display of this invention;

FIG. 8 is a cross-sectional view showing another example of an organic EL display of this invention; and

FIG. 9 is a cross-sectional view showing another example of an organic EL display of this invention.

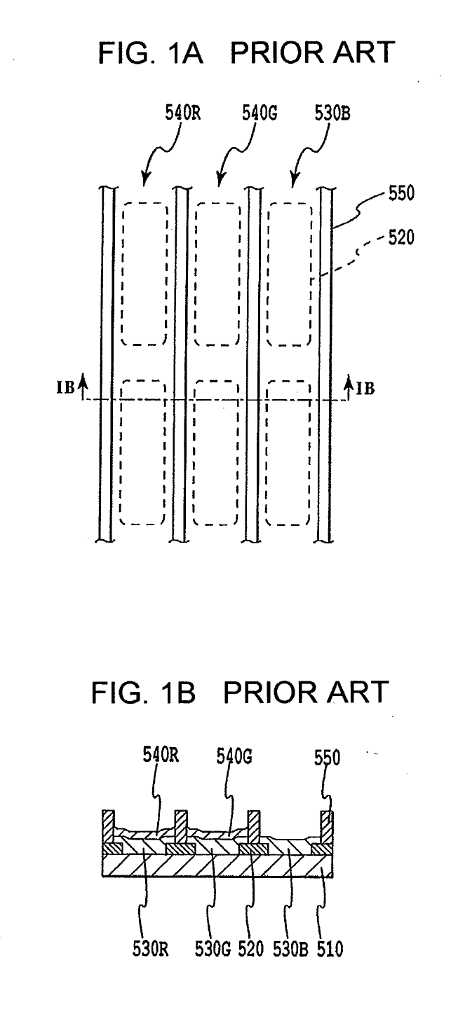

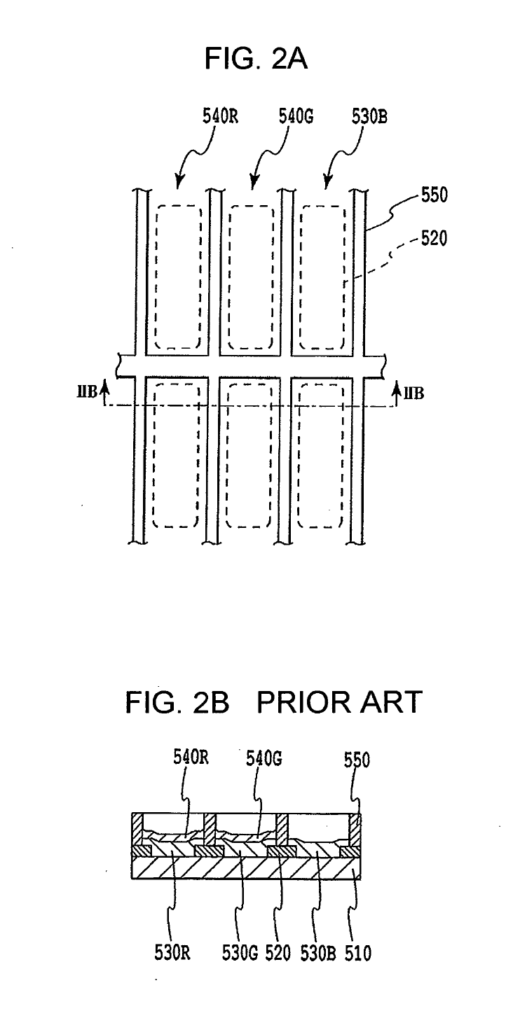

### EXPLANATION OF REFERENCE NUMERALS

1 Color conversion filter substrate
2 Organic EL emission substrate
3 Color filter substrate
4 Color-conversion organic EL emission substrate
10, 510 Transparent substrate
20, 520 Black matrix
30, 530(R,G,B) Color filter (R, G, B)
40, 540(R,G) Color conversion layer (R,G)
50, 550 Bank
60 Spacer
70, 570 Ink liquid drop during flight
72, 572 Ink liquid drop upon adhesion
110 Substrate
120 Switching element
130 Planarization layer
140 Reflective electrode
150 Insulating layer
160 Organic EL layer
170 Transparent electrode
180 Barrier layer
190 Filler layer

### BEST MODE FOR CARRYING OUT THE INVENTION

This invention relates to a flat panel display, comprising:

a color conversion filter substrate, including a transparent substrate, a black matrix having a plurality of opening portions and which delimits red, green and blue subpixels, red and green color filters formed in red and green subpixels, a bank, and a red color conversion layer and green color conversion layer formed in the red and green subpixels; and

an emission substrate having a plurality of emission portions;

and characterized in that

the bank is formed from a blue-light transmissive material which transmits at least blue light, and moreover has opening portions at the red subpixels and green subpixels; and, in all of the red and green subpixels on the flat panel display, the centers of opening portions of the bank are decentered to the blue subpixel side with respect to the centers of the opening portions of the black matrix. [This invention also relates to] a method of manufacturing [such a flat panel display], and to a color conversion filter substrate used in this method of manufacture.

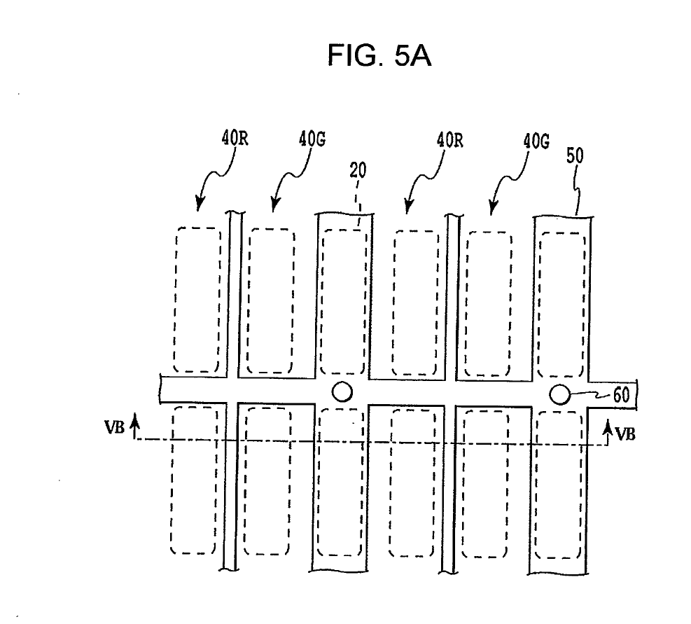

One mode of a color conversion filter substrate of this invention is shown in FIG. 4A and FIG. 4B. FIG. 4A is a top view of the color conversion filter substrate, and FIG. 4B is a cross-sectional view of the color conversion filter substrate along section line IVB-IVB in FIG. 4A. The color conversion filter substrate includes a transparent substrate 10, black matrix 20, red, green and blue color filters 30(R,G,B), a bank 50, a red color conversion layer 40R, a green color conversion layer 40G, and spacers 60. Here, the bank 50 is formed from a plurality of stripe-shape portions extending in the vertical direction. Of the above-described constituent elements, the blue color filter 30B and spacers 60 are optionally selected elements which can be provided as necessary.

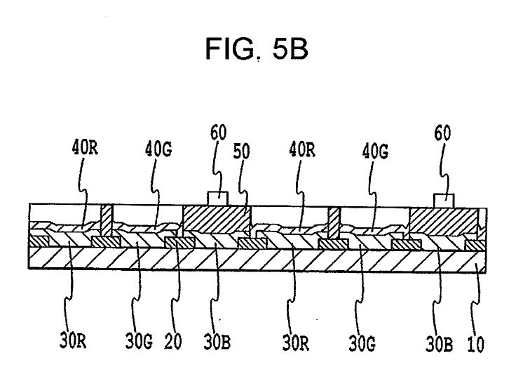

Another mode of a color conversion filter substrate of this invention is shown in FIG. 5A and FIG. 5B. FIG. 5A is a top view of the color conversion filter substrate, and FIG. 5B is a cross-sectional view of the color conversion filter substrate along section line VB-VB in FIG. 5A. The color conversion filter substrate shown in FIG. 5A and FIG. 5B is similar to the color conversion filter substrate shown in FIG. 4A and FIG. 4B, except for the fact that the bank 50 is formed in a mesh shape.

The transparent substrate 10 can be formed using an optional material which is transparent to light in the visible light region, and which moreover can withstand the various conditions used in forming other constituent layers (for example, solvents used, temperatures, and similar). Further, it is desirable that the transparent substrate 10 have excellent dimensional stability. Materials used to form the transparent substrate 10 include glass, or polyolefins, polymethyl methacrylate or other acrylic resins, polyethylene terephthalate or other polyester resins, polycarbonate resins, polyimide resins, and other resins. When the above-described resins are used, the transparent substrate 10 may be rigid, or may be flexible.

The black matrix 20 has a plurality of opening portions which clearly delimit red, green and blue subpixels, and is a layer which contributes to improvement of the contrast ratio of the flat panel display. The black matrix 20 can adopt a mesh-shape configuration in which a plurality of rectangle-shape opening portions are arranged in the vertical direction and horizontal direction, as shown in FIG. 4A and FIG. 5A. Or, the black matrix 20 may be formed from a plurality of stripe-shape portions extending in the vertical direction. In this case, opening portions between adjacent stripe-shape portions of the black matrix 20 delimit sets of subpixels arrayed in the vertical direction.

A black matrix 20 of this invention can be formed using black matrix materials commercially marketed as materials for flat panel displays. The film thickness of the black matrix 20 is generally approximately 1 to 2 μm. The black matrix 20 can be formed by applying a commercially marketed black matrix material to the entire surface by spin coating, roll coating, casting, dip coating, or another application method, performing patterned exposure to cause partial hardening, and removing unhardened regions.

A color filter 30 is a layer formed in opening portions of the subpixels of each color delimited by the black matrix 20, and passes light in a specific wavelength range to obtain a desired hue. A color conversion filter substrate of this invention includes at least a red color filter 30R provided in red subpixels, and a green color filter 30G provided in green subpixels. Optionally, a color conversion filter substrate of this invention may include a blue color filter 30B provided in blue subpixels. In FIG. 4A through FIG. 5B, examples are shown in which a blue color filter 30B is formed. In this invention, all of the red subpixels and green subpixels are adjacent to at least one blue subpixel. As shown in FIG. 4A and FIG. 5A, a color filter 30 may have stripe shapes extending along a plurality of opening portions arrayed in the vertical direction. Here, as shown in FIG. 4B and FIG. 5B, peripheral portions of color filters 30 may be formed on the black matrix 20. Or, color filters 30 may have rectangle shapes corresponding to the opening portions between the black matrixes 20.

A color filter 30 can be formed using color filter materials commercially marketed as flat panel display materials. The color filter 30 can be formed by applying a commercially marketed color filter material to the entire surface by spin coating, roll coating, casting, dip coating, or another application method, performing patterned exposure to cause partial hardening, and removing unhardened regions.

A bank 50 is formed from blue-light transmissive material. In this invention, “blue-light transmissive material” means material which transmits at least blue light. In this invention, “blue-light transmissive material” includes transparent materials which transmit the entirety of light in the visible range, blue materials which transmit only blue light, cyan color materials which transmit blue light and green light, magenta color materials which transmit blue light and red light, and similar. It is preferable that a blue-light transmissive material be a transparent material or a blue material.

The bank 50 has opening portions in positions corresponding to the red subpixels and green subpixels delimited by the black matrix 20. In the mode shown in FIG. 4A, the bank 50 comprises a plurality of stripe-shape portions, formed on the black matrix 20 forming the boundary between red subpixels and green subpixels, and on the blue color filter 30 of the blue subpixels. In the mode shown in FIG. 5A, the bank 50 has a mesh shape, formed on the black matrix 20 forming the boundary between red subpixels and green subpixels, on the blue color filter 30 of the blue subpixels, and on the black matrix 20 extending in the horizontal direction forming the boundary between two subpixels of the same color. By forming the bank 50 in the positions thus described, the centers of opening positions of the bank 50 in all of the red subpixels on the color conversion filter substrate (that is, the flat panel display) are decentered to the blue subpixel side compared with the centers of the opening portions of the black matrix 20. Similarly, the centers of opening positions of the bank 50 in all of the green subpixels on the color conversion filter substrate (that is, the flat panel display) are also decentered to the blue subpixel side compared with the centers of the opening portions of the black matrix 20.

The bank 50 can be formed using a photosetting material, photo/thermosetting material, thermoplastic material, or similar which is blue-light transmissive. When using a photosetting material or a photo/thermosetting material which is blue-light transmissive, the bank 50 can be formed by applying the material to the entire surface by spin coating, roll coating, casting, dip coating, or another application method, performing patterned exposure to cause partial hardening or temporary hardening, and removing unhardened regions. When using a photo/thermosetting material, it is desirable that heating be further performed, to promote hardening of the bank 50. Or, when using a thermoplastic material which is blue-light transmissive, the bank 50 can be formed using screen printing or another printing method.

A color conversion layer 40 is a layer which absorbs light emitted by an emission substrate, performs wavelength distribution conversion, and emits light with a different hue. In this invention, a red color conversion layer 40R is formed in red subpixels, and a green color conversion layer 40G is formed in green subpixels. In this invention, a color conversion layer 40 is formed from one type, or a plurality of types, of color conversion dyes. An arbitrary color conversion due known in the prior art can be used to form a color conversion layer 40.

Formation of a color conversion layer 40 can be performed by preparing ink containing one type or a plurality of types of color conversion dyes and a solvent, using an inkjet method to cause the ink to adhere to opening portions of the bank 50, and by heating and drying the adhering ink and removing the solvent.

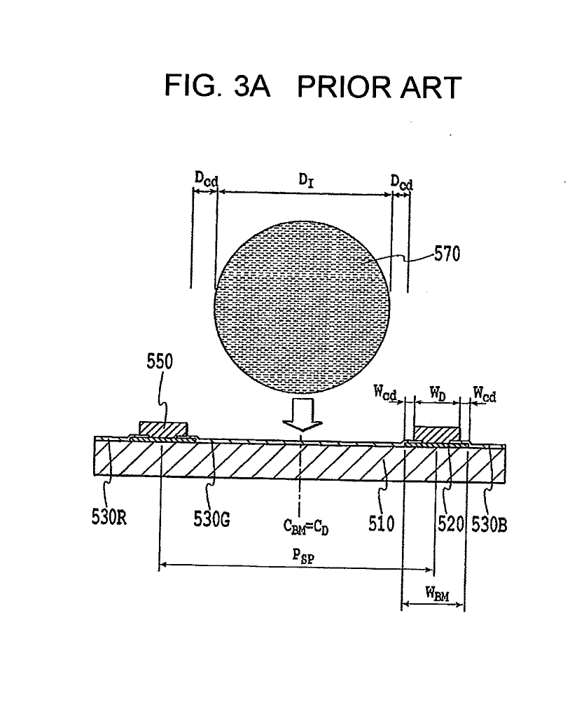

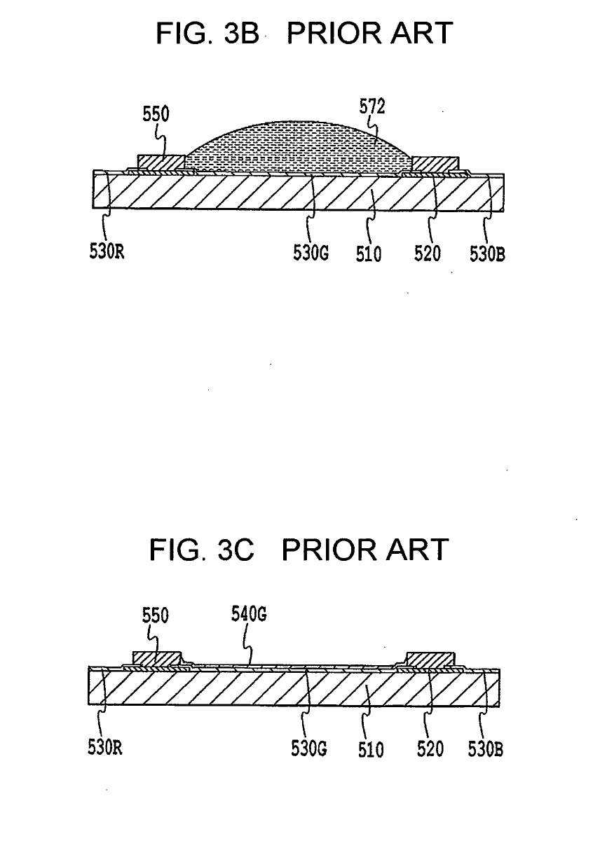

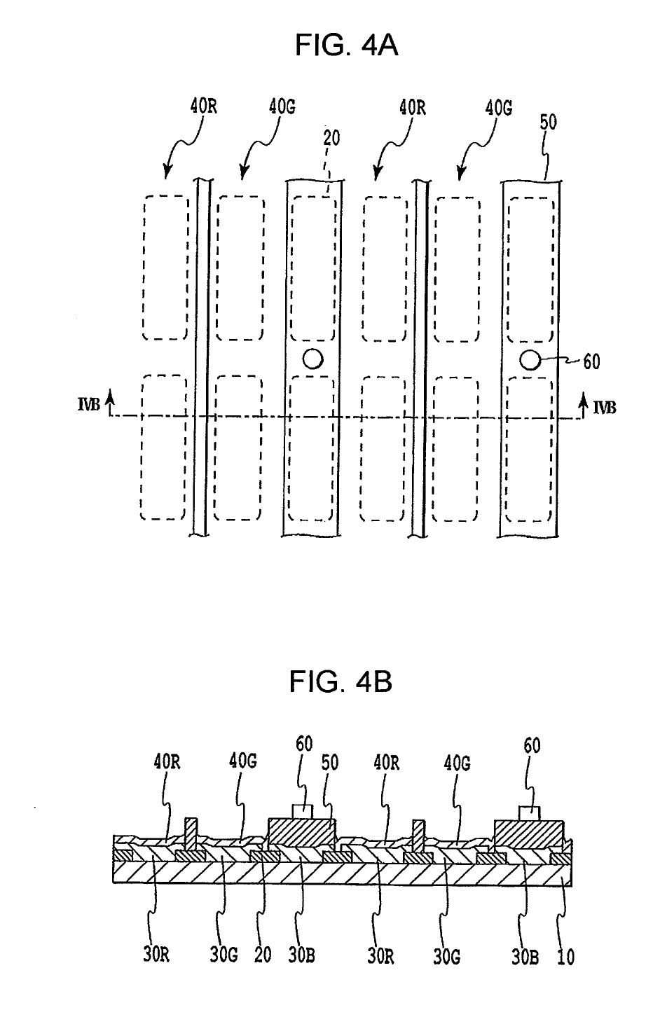

Formation of a color conversion layer 540 in a color conversion filter substrate of the prior art is explained referring to FIG. 3A through FIG. 3C. In FIG. 3A through FIG. 3C, formation of a green color conversion layer 540G is shown as an example. In FIG. 3A, the bank 550 is provided on the black matrix 520 on the boundary of red subpixels and green subpixels, and on the black matrix 520 on the boundary of green subpixels and blue subpixels. As a result, the centers C_{D} of opening portions of the bank 550 coincide with the centers C_{BM} of opening portions of the black matrix 520. If the width of the bank 550 is W_{D}, and the positioning tolerance when forming the bank 50 is W_{cd}, then in order to provide the bank 550 at desired positions on the black matrix 20, the width W_{BM} of the black matrix must satisfy the relation W_{BM}≧W_{D}+2W_{cd}. Here, if P_{SP} is the horizontal-direction pitch of subpixels (that is, the black matrix width W_{BM}+black matrix opening portion width), then the minimum value of opening widths of the bank 550 is determined from

P_{SP}−W_{D}−2W_{cd} (Expression 1)

Further, if the diameter of an ink liquid drop 570 is D_{I}, and the impact tolerance thereof is D_{cd}, then the minimum opening width of the bank 550 is determined from P_{SP}−W_{d}−2W_{cd}. Hence in order for an ink liquid drop 570 to make impact in an opening portion of the bank 550, the relation

D_{I}≦P_{SP}−W_{D}−2W_{cd}−2D_{cd} (Expression 2)

must be satisfied.

Next, the ink liquid drop 572 which has made impact spreads in a region between two banks 550, and assumes a state of bulging to exceed the upper faces of the banks 550, as shown in FIG. 3B. Then, spreading in the substrate vertical direction (the directions into the paper and out of the paper in FIG. 3B) occurs, and by heating and drying to remove the solvent in the ink liquid drop, a green color conversion layer 540G is formed. Here, when a green color conversion layer 540G of the desired film thickness is not obtained by adhesion of one ink liquid drop, ink adhesion and heating and drying are repeatedly performed, to form a green color conversion layer 540G of the desired film thickness.

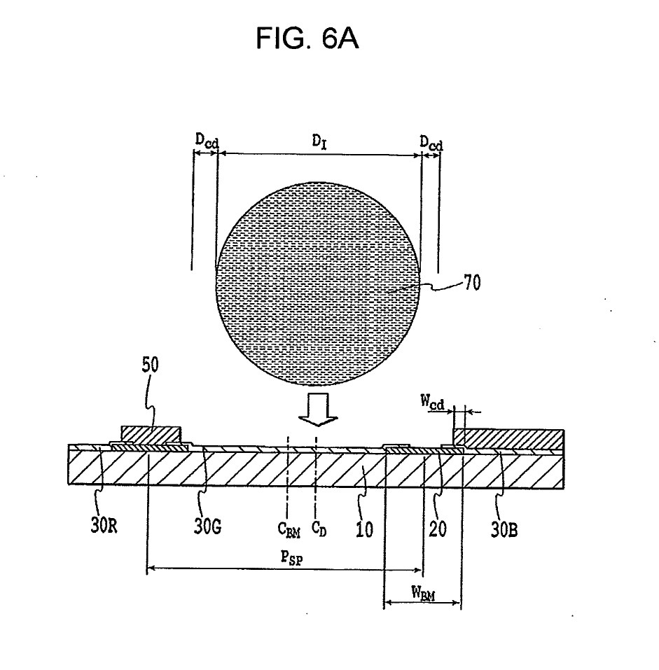

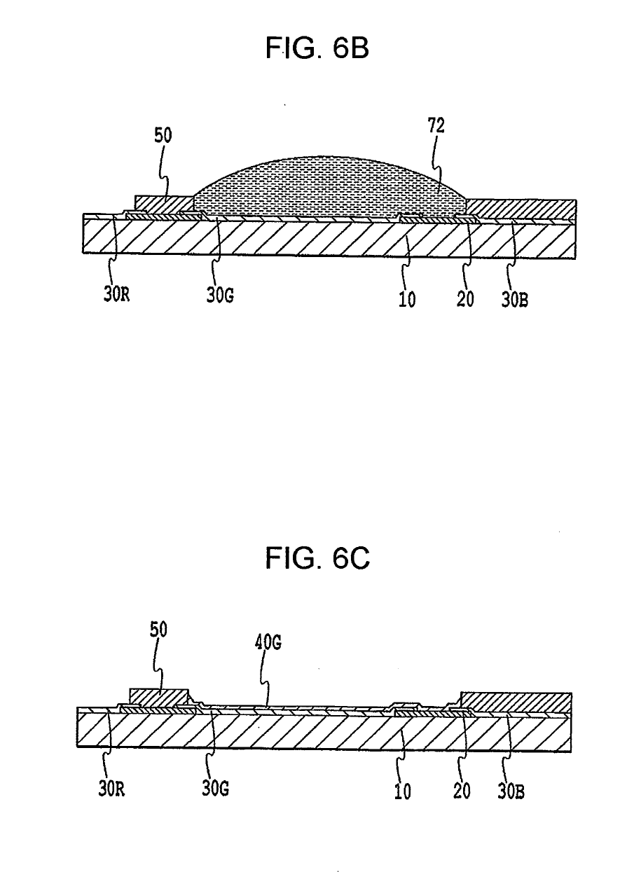

Next, formation of a color conversion layer 40 on a color conversion filter substrate of this invention is explained, referring to FIG. 6A through FIG. 6C. In FIG. 6A through FIG. 6C also, formation of a green color conversion layer 40G is shown as an example. In FIG. 6A, the bank 50 is provided on the black matrix 20 on the boundary of red subpixels and green subpixels, and on blue subpixels (more specifically, above the opening portions of the black matrix 20 delimiting blue subpixels). As a result, the centers C_{D} of opening portions of the bank 50 do not coincide with the centers C_{BM} of opening portions of the black matrix 20, but are decentered to the blue subpixel side. With respect to the bank provided on the black matrix 20 on the boundary of red subpixels and green subpixels, similarly to the case of FIG. 3A through FIG. 3C, in order to provide the bank 550 at desired positions on the black matrix 20, the width W_{BM} of the black matrix must satisfy the relation W_{BM}≧W_{D}+2W_{cd} (here W_{D} indicates the width of the bank 50, and W_{cd} indicates the positioning tolerance when forming the bank 50). On the other hand, with respect to the bank provided on blue subpixels, there is the possibility of formation on the black matrix 20 at the boundary of green subpixels and blue subpixels by the amount W_{CD}. Hence the minimum value of opening widths of the bank 50 is determined from

P_{SP}−W_{D} (Expression 3)

(Here P_{SP} indicates the horizontal-direction pitch of subpixels). Hence, if the diameter of an ink liquid drop 70 is D_{I}, and the impact tolerance thereof is D_{cd}, then in order for an ink liquid drop 70 to make impact in an opening portion of the bank 50, the relation

D_{I}≦P_{SP}−2W_{cd}−2D_{cd} (Expression 4)

must be satisfied.

Next, the ink liquid drop 72 which has made impact spreads in a region between two banks 50, and assumes a state of bulging to exceed the upper faces of the banks 50, as shown in FIG. 6B. Then, spreading in the substrate vertical direction (the directions into the paper and out of the paper in FIG. 6B) occurs, and by heating and drying to remove the solvent in the ink liquid drop, a green color conversion layer 40G is formed. Here, when a green color conversion layer 40G of the desired film thickness is not obtained by adhesion of one ink liquid drop, ink adhesion and heating and drying are repeatedly performed, to form a green color conversion layer 40G of the desired film thickness. A similar method is used to form a red color conversion layer 40R.

As is clear from comparison of the above equations (1) and (3), by forming the bank on the blue subpixels rather than on the black matrix on the boundary of green subpixels and blue subpixels, the opening portions of the bank 50 in the color conversion filter substrate of this invention spread further than in a color conversion filter substrate of the prior art my the amount of the line width W_{D} of the bank 50. Hence when the diameter D_{I} of an ink liquid drop 70 and the impact tolerance D_{cd} are equal, in a color conversion substrate filter of this invention it is possible to reduce P_{SP} by the amount W_{D}, that is, it is possible to improve the resolution.

Further, as is clear from comparison of the above equations (2) and (4), when using the same subpixel pitch P_{SP}, the diameter D_{I} of an ink liquid drop 70 which can be received by a color conversion filter substrate of this invention is greater by the amount of the line width W_{D} of the bank 50 than for a color conversion filter substrate of the prior art. In a color conversion filter substrate of this invention, a color conversion layer 40 becomes larger by the amount of the width W_{D} of the opening portions of the bank 50 formed, and the area in which the color conversion layer is to be formed becomes larger in proportion to the width of the opening portions. However, when the diameter D_{I} of the ink liquid drops 70 is increased, the volume of the ink liquid drops 70 increases in proportion to the cube of the diameter D₁, and the film thickness of the color conversion layer 40 formed by adhesion of one link liquid drop increases markedly. Hence when forming color conversion layers 40 with the same film thickness, the number of ink liquid drops 70 required can be reduced, and the manufacturing time and manufacturing cost can be reduced.

There is a slight advantageous result due to differences in the line width W_{D} of the bank 50, but the above-described advantageous result becomes prominent with improved fineness of the color conversion filter substrate. For example, flat panel displays with a fineness of 140 to 150 ppi have come to be used in recent portable telephones. At a fineness of 140 ppi, for example, in a conventional structure the horizontal-direction pitch of subpixels P_{SP} is approximately 60 μm, and the bank line width W_{D} is approximately 10 μm. In this case, as is clear from a comparison of equations (1) and (3), in a color conversion filter substrate of this invention, the width of the bank opening portions can be maintained the same even when the subpixel horizontal-direction pitch P_{SP} is reduced to approximately 50 μm. A PSP of approximately 50 μm is equivalent to a fineness of 170 ppi. That is, even when a conventional inkjet apparatus is employed without modification, an improvement in fineness of approximately 30 ppi is possible.

Further, if the subpixel horizontal-direction pitch P_{SP} is made 50 μm, the bank line width W_{D} is made 10 μm, and the ink liquid drop impact tolerance D_{cd} is made 10 μm, then from equation (2), the maximum value of the ink liquid drop diameter D_{I} that can be received by a conventional color conversion filter substrate is calculated to be 20 μm. On the other hand, from equation (4), the maximum value of the ink liquid drop diameter D_{I} that can be received by a color conversion filter substrate of this invention is calculated to be 30 μm. Here, whereas the width of bank opening portions forming the color conversion layers in a conventional color conversion filter substrate is 40 μm (=P_{SP}−W_{D}), the bank opening portion width in this invention is 50 μm, and the area in which color conversion layers are formed is increased by 1.25 times. However, the maximum value of the ink liquid drop volume is 3.375 times (=(30/20)³). Hence the film thickness of a color conversion layer formed by adhesion of one ink liquid drop can be at most 2.7 times greater. This means that the number of times adhesion of ink liquid drops is performed, which in the prior art had been from several times to tens of times, can be reduced, resulting in the possibility of greatly reduced manufacturing time and greatly reduced manufacturing cost. However, it can easily be understood by a practitioner of the art that the number of times to which ink liquid drop adhesion can be reduced without causing color mixing of color conversion layers depends on the bank height, liquid-repellent treatment of the bank surface, ink viscosity, and similar.

A color conversion filter substrate of this invention may include a protective layer (not shown), formed covering the color conversion layers 40 and bank 50 and lower layers, with the object of preventing degradation of color conversion layers 40 or of preventing outflow of color conversion dyes to a filler layer (described below) or similar. A protective layer can be formed using an inorganic material or a resin.

Further, a color conversion filter substrate of this invention may further include spacers 60 formed on the bank 50. Spacers 60 are useful for delimiting a distance between the emission substrate and the color conversion filter substrate when bonding the two substrates, as described below.

An emission substrate forming a flat panel display of this invention may have an arbitrary known configuration, having a plurality of emission portions. It is preferable that the emission substrate be an organic EL emission substrate.

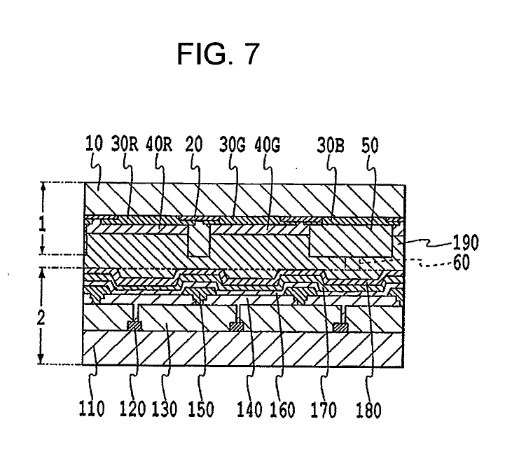

FIG. 7 shows one example of a flat panel display of this invention which uses an organic EL emission substrate as the emission substrate. The color conversion filter substrate 1 may have the stripe-shape banks 50 shown in FIG. 4A and FIG. 4B, or may have a mesh-shape bank 50 shown in FIG. 5A and FIG. 5B.

The organic EL emission substrate 2 may adopt any arbitrary configuration, with the condition that light is emitted on the side opposite the substrate 110. The organic EL emission substrate 2 shown in FIG. 7 includes a substrate 110, a plurality of switching elements 120, a planarization layer 130, a reflective electrode 140, an insulating layer 150 having a plurality of opening portions, an organic EL layer 160, a transparent electrode 170, and a barrier layer 180. In the example of FIG. 7, the substrate 110, reflective electrode 140, organic EL layer 160, and transparent electrode 170 are necessary constituent elements; other layers are constituent elements which may be provided optionally.

The substrate 110 can be formed using an arbitrary material which can withstand the various conditions used in forming other constituent layers (for example, solvents used, temperatures, and similar). Further, it is desirable that the transparent substrate 110 have excellent dimensional stability. Materials used to form the transparent substrate 110 include glass, or polyolefins, polymethyl methacrylate or other acrylic resins, polyethylene terephthalate or other polyester resins, polycarbonate resins, polyimide resins, and other resins. When the above-described resins are used, the transparent substrate 110 may be rigid, or may be flexible. Or, the substrate 110 may be formed using silicon, ceramics, or other opaque materials. The plurality of switching elements 120 can be formed using TFTs or other arbitrary elements known in the art.

The planarization layer 130 is a layer to planarize the depressions and protrusions occurring due to formation of the switching elements 120. The planarization layer 130 may include a plurality of contact holes to connect the switching elements 120 with the reflective electrode 140. The planarization layer 130 normally is formed using a resin material. A passivation layer (not shown), comprising a single-layer film of SiO₂, SiN, SiON or similar, or a multilayer film in which a plurality of these are layered, may be formed on the planarization layer 130. The passivation layer prevents intrusion into the organic EL layer 160 and similar of outgassing from the resin forming the planarization layer 130.

The reflective electrode 140 is formed using MoCr, CrB, Ag, an Ag alloy, an Al alloy, or another metal or alloy having high reflectivity. The reflective electrode 140 is preferable formed from a plurality of partial electrodes, and the partial electrodes are connected one-to-one to the switching elements 120. The reflective electrode 140 may be a layered member of a plurality of layers. For example, a reflective electrode 140 having a layered structure of an underlayer to secure close adhesion to the planarization layer or passivation layer, a reflective layer, and a transparent layer, can be used. Here, the underlayer and transparent layer can be formed using IZO, ITO, or other transparent conductive oxide materials, and the reflective layer can be formed using the above-described metals or alloys having high reflectivity.

The insulating layer 150 is a layer having a plurality of opening portions, and delimits a plurality of emission portions of the organic EL emission substrate 2. When the reflective electrode 140 is formed from a plurality of partial electrodes as described above, the insulating layer 150 covers the shoulder portions of these partial electrodes, and has opening portions so as to expose the upper surfaces of the partial electrodes. The insulating layer 150 is formed using SiO₂, SiN, SiON, or another inorganic insulating material, or using an organic insulating material. The insulating layer 150 may be formed by layering an organic insulating material and an inorganic insulating material.

The organic EL layer 160 includes at least an organic emission layer. The organic EL layer 160 may further include, as necessary, a hole injection layer, hole transport layer, electron transport layer, and/or electron injection layer. Each of the layers forming the organic EL layer 160 can be formed using well-known compounds or compositions.

The transparent electrode 170 is formed from IZO, ITO, or another transparent conductive oxide material film, or from a semitransparent metal film having a film thickness of several nanometers to 10 nm. When forming the transparent electrode 170 using a transparent conductive oxide material, a damage mitigation layer (not shown) may be provided between the organic EL layer 160 and the transparent electrode 170, in order to prevent damage to the organic EL layer 160 during formation of the transparent electrode 170. The damage mitigation layer is formed using MgAg, Au, or another metal having high optical transmissivity, and has a film thickness of approximately several nanometers.

The barrier layer 180 is formed from a single-layer film or layered film of SiO₂, SiN, SiON, or another inorganic insulating material. The barrier layer 180 is effective for preventing intrusion of water or oxygen into the organic EL layer 160, and for suppressing the occurrence of emission faults.

In forming each of the layers of the organic EL emission substrate 2, arbitrary means known in the art can be used.

Finally, while positioning the opening portions of the black matrix 20 of the color conversion filter substrate 1 with the emission portions (specifically, the opening portions of the insulating layer 150) of the organic EL emission substrate 2, by bonding together the color conversion filter substrate 1 and the organic EL emission substrate 2, a flat panel display of this invention is obtained.

Here, the air gap formed between the color conversion filter substrate 1 and the organic EL emission substrate 2 may be filled using a liquid or solid material, to form a filler layer 190. A filler layer 190 is effective for reducing the refractive index difference in the propagation path of light emitted by the organic EL layer 160, and for improving the light extraction efficiency. A filler layer 190 can for example be formed using a thermosetting adhesive or similar.

When bonding together the color conversion filter substrate 1 and the organic EL emission substrate 2, arbitrary means known in the art can be used.

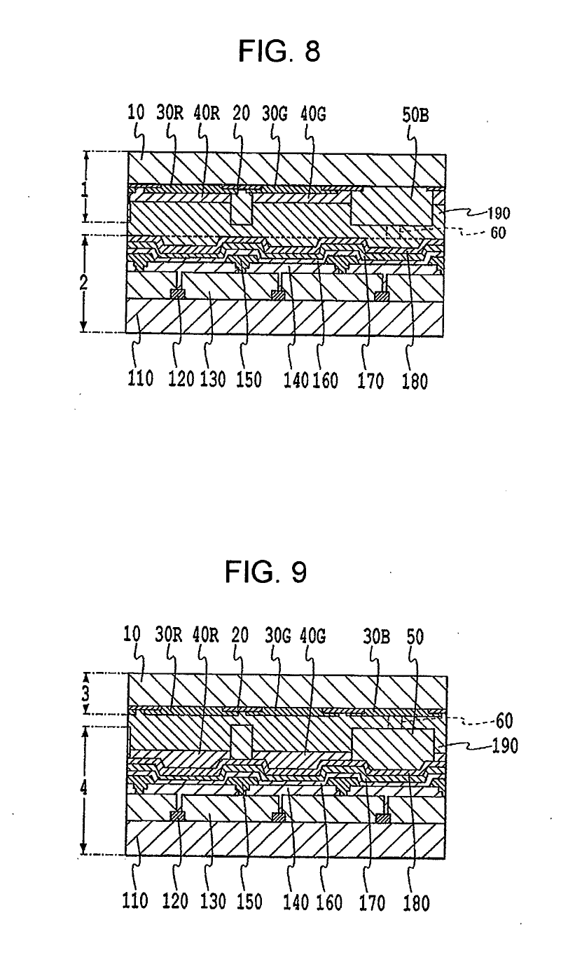

FIG. 8 shows another example of a flat panel display of this invention. The configuration of FIG. 8 is similar to that of the above-described flat panel display, except for the facts that a blue color filter 30B is not formed, and that blue material is used to form a blue bank 50B. In the configuration of FIG. 8, the blue bank 50B functions as a barrier wall when using an inkjet method to form the red color conversion layer 40R and green color conversion layer 40G, and functions as a color filter which transmits blue light of a desired hue. It is desirable that the material used to form the blue bank 50B be adjusted so as to satisfy both the above-described functions.

Further, this invention relates to a flat panel display, having:

an organic EL emission substrate, including a substrate, a reflective electrode, an insulating layer which has a plurality of opening portions, and which delimit red emission portions, green emission portions and blue emission portions, an organic EL layer, a transparent electrode, a bank, a red color conversion layer formed in positions corresponding to red subpixels, and a green color conversion layer formed in positions corresponding to green subpixels; and

a color filter substrate, including a transparent substrate, and red and green color filters,

the organic EL emission substrate being characterized in that

the bank is formed from a blue-light transmissive material which transmits at least blue light, and has opening portions in the red emission portions and green emission portions; and

in every red emission portion and green emission portion on the flat panel display, the centers of opening portions of the bank are decentered to the blue emission portion side with respect to the centers of the opening portions of the insulating layer. [This invention also relates to] a method of manufacturing [such a flat panel display], and to an organic EL emission substrate used in this method of manufacture.

FIG. 9 shows an example of a flat panel display formed from an organic EL emission substrate 4 having color conversion layers (hereafter called a “color-conversion organic EL emission substrate 4”), and a color filter substrate 3.

The color filter substrate 3 includes as necessary elements a transparent substrate 10 and red and green color filters 30(R,G). The color filter substrate 3 may further include, as necessary, a black matrix 20, blue color filter 30B, and/or spacers 60. Each of the constituent layers of the color filter substrate 3 may have materials and configurations similar to layers corresponding to a color conversion filter substrate 1, and moreover can be formed by similar formation methods.

The color-conversion organic EL emission substrate 4 has a configuration similar to that of the above-described organic EL emission substrates 2, except for the fact of having a bank 50 formed from blue-light transmissive material, a red color conversion layer 40R, and a green color conversion layer 40G. The red color conversion layer 40R and green color conversion layer 40G are provided in positions corresponding to the red color filter 30R and green color filter 30G respectively of the color filter substrate 3. Each of the layers, from the substrate 110 to the barrier layer 180, uses material similar to that of the corresponding layer in the above-described organic EL emission substrates 2, and can be formed using a similar formation method.

In this example, the reflective electrode 140 is formed from a plurality of partial electrodes. And, the insulating layer 150 covers the shoulder portions of the plurality of partial electrodes, and has a plurality of opening portions exposing the upper surfaces of the partial electrodes. The plurality of opening portions delimit the emission portions in the color-conversion organic EL emission substrate 4. Each of the emission portions emits light ranging from blue to blue-green light. However, the color output from each of the emission portions to the outside is determined by the color conversion layer 40 and by the color of the color filter 30 in the color filter substrate 3, existing in the corresponding position. In this example, emission portions emitting blue, green, and red light to the outside are respectively called blue emission portions, green emission portions, and red emission portions. Further, when in this embodiment no blue color filter 30B exists, subpixels with no color filter 30 existing at the corresponding position are blue emission portions.

The bank 50 on the color-conversion organic EL emission substrate 4 is formed on the boundary of the resin emission portions and the green emission portions, and on the blue emission portions. As a result, the centers of opening portions of the bank 50 in all the red emission portions and green emission portions are decentered to the blue emission portion side with respect to the centers of the opening portions of the insulating layer 150. Similarly to the decentering of the bank in the above-described color conversion filter substrate 1, this decentering yields the advantageous results of improving fineness using a conventional inkjet apparatus, as well as of reducing manufacturing time and manufacturing cost by increasing the diameter of the ink liquid drops.

The bank 50 can be formed using methods and materials similar to those described above. However, in consideration of the fact that resistance of an organic EL layer to water, oxygen, and heat is not very high, it is desirable that the formation conditions be adjusted.

The red color conversion layer 40R and green color conversion layer 40G are formed within opening portions of the bank 50 using materials and an inkjet method similar to those described above. In a configuration which uses a color-conversion organic EL emission substrate 4, compared with the configuration described above in which a color conversion filter substrate 1 and organic EL emission substrate 2 are bonded together, layers having a low refractive index (barrier layer 180, filler layer 190, and similar) do not exist between the organic EL layer 160 and the color conversion layers 40. This is effective for suppressing reflection at layer interfaces and improving the incidence efficiency on the color conversion layers 40. Shortening the distance between the organic EL layer 160 and the color conversion layers 40 is also effective for improving the rate of incidence of light on the color conversion layers 40.

### PRACTICAL EXAMPLES

### Practical Example 1

This practical example relates to an organic EL display having the structure of FIG. 7 and a nominal dimension of approximately 3 inches. Pixels in the organic EL display of this practical example are arranged at a pitch of 150 μm×150 μm. Each pixel is formed from red, green, and blue subpixels, arranged with a pitch of 50 μm×150 μm.

On a substrate 110 comprising alkali-free glass (AN-100, manufactured by Asahi Glass Co., Ltd.) 200×200 mm×thickness 0.7 mm, a plurality of switching elements 120 for a screen, formed from TFTs and similar, and wiring therefore, were formed. Next, a planarization layer 130 of film thickness 3 μm and an SiO₂ passivation layer of film thickness 300 nm were formed so as to cover the switching elements 120, and contact holes for connection to the switching elements 120 were formed in the planarization layer 130 and passivation layer. Next, an RF magnetron sputtering apparatus was used to form an IZO film with a film thickness of film thickness 50 nm in Ar gas. On the IZO film was applied a resist (OFRP-800, manufactured by Tokyo Ohka Kogyo Co., Ltd.), and exposure and development were performed to form an etching mask. Next, wet etching of the IZO film was performed, and an IZO film separated into subpixels was formed. After removing the etching mask, a sputtering method was used to form an Ag alloy film of film thickness 200 nm on the separated IZO film. A procedure similar to that for the IZO film was used to perform patterning of the Ag alloy film, and a reflective electrode 140, having an IZO/Ag alloy layered structure, was formed. The reflective electrode 140 comprised a plurality of partial electrodes for subpixels, and each of the partial electrodes was connected one-to-one with a witching element 120 by IZO in a contact hole. On the reflective electrode 140, a spin coating method was used to apply a novolac system resin (JEM-700R2, manufactured by JSR Corp.) with film thickness 1 μm, exposure and development were performed, and an insulating layer 150 having opening portions was formed on the upper surface of the reflective electrode 140. The insulating layer 150 was formed so as to cover the shoulder portions of the plurality of partial electrodes forming the reflective electrode 140, and so as to expose the upper surfaces of the partial electrodes.

Then, the layered member with the insulating layer 150 formed was moved into a resistive heating evaporation deposition apparatus. A cathode buffer layer (not shown) comprising Li of film thickness 1.5 nm was formed on the reflective electrode 140. Next, the pressure within the resistive heating evaporation deposition apparatus was reduced to 1×10⁻⁴ Pa, and an electron transport layer of film thickness 20 nm comprising tris (8-hydroxyquinolinato) aluminum (Alq₃), an organic emission layer comprising 4,4′-bis (2,2′-diphenylvinyl)biphenyl (DPVBi) of film thickness 30 nm, a hole transport layer comprising 4,4′-bis[N-(1-naphthyl)-N-phenylamino] biphenyl (α-NPD) of film thickness of 10 nm, and a hole injection layer comprising copper phthalocyanine (CuPc) of film thickness of 100 nm, were formed, to obtain an organic EL layer 160. Formation of each of the constituent layers of the organic EL layer 160 was performed at an evaporation deposition rate of 0.1 nm/s. Next, a damage mitigation layer (not shown) comprising MgAg of film thickness 5 nm was formed on the organic EL layer 160. The layered member with the organic EL layer 160 formed was then moved into a facing sputtering apparatus without breaking the vacuum. A sputtering method was used to layer IZO with a film thickness of 200 nm, to form a transparent electrode 170. In forming layers from the cathode buffer layer to the transparent electrode 170, a metal mask was used having opening portions corresponding to each of a plurality of screens, and deposition of materials at the boundary portions of the plurality of screens was prevented.

Then, the layered member with the transparent electrode 170 formed was moved into a CVD apparatus without breaking the vacuum. A CVD method was used to layer SiN of film thickness 2 μm over the entire face of the substrate, forming a barrier layer 180, and an organic EL emission substrate 2 was obtained.

Color Mosaic (a registered trademark) CK-7001 (available from Fujifilm Corp.) was applied onto a transparent substrate 10 comprising 200×200 nm×0.7 nm thick alkali-free glass (Eagle 2000, manufactured by Corning Inc.), patterning was performed, and a black matrix 20 of film thickness 1 μm and markers (not shown) were formed. The black matrix 20 had a mesh shape with a plurality of opening portions, of width 36 μm in the horizontal direction, in positions corresponding to subpixels of each color, and had a line width W_{BM} of 14 μm. Then, Color Mosaic (a registered trademark) CR-7001, CG-7001, and CB-7001 (all available from Fujifilm Corp.) were used to form red, green and blue color filters 30(R,G,B). Each of the color filters 30(R,G,B) of each color was formed from a plurality of stripe-shape portions extending in the vertical direction, and the film thicknesses of each were a film thickness of 1.5 μm. The color filters 30(R,G,B) of each color were arranged repeatedly in the horizontal direction in the order red, green, blue.

Next, a transparent photosensitive resin (CR-600, manufactured by Hitachi Chemical Co., Ltd.) was applied to the color filter, patterning was performed, a bank 50 comprising a plurality of stripe-shape portions extending in the vertical direction was formed, and a color filter substrate was obtained. The bank 50 was formed from a plurality of stripe-shape portions formed on the black matrix 20 of the boundary of green subpixels and red subpixels, and on the blue color filter 30B of blue subpixels. The stripe-shape portions formed on the boundary of green subpixels and red subpixels had a width of approximately 10 μm, and the stripe-shape portions formed on the blue subpixels had a width of approximately 40 μm. The bank 50 had a height of approximately 4 μm. The height of the bank 50 in this invention means the distance in the plumb direction from the upper surfaces of the red and green color filters 30(R,G) to the upper surface of the bank 50. By means of the above processes, a bank 50 could be formed having opening portions of width 50 μm on red and green subpixels having a horizontal-direction dimension of 50 μm. In the red and green subpixels of the color conversion filter substrate of this practical example, the centers C_{D} of the opening portions of the bank 50 are decentered approximately 5 μm to the blue subpixel side with respect to the centers C_{BM} of the opening portions of the black matrix 20.

Again, a transparent photosensitive resin (CR-600, manufactured by Hitachi Chemical Co., Ltd.) was applied, and patterning performed, to form a plurality of spacers 60 on the bank 50 at positions on the boundary of two adjacent blue subpixels. Each of the spacers 60 had a columnar shape with a diameter of approximately 15 μm and a height of approximately 2 μm. The color filter substrates with spacers 60 formed were heated and dried.

Next, a green color conversion layer formation ink was prepared by dissolving 50 parts by weight of a mixture of coumarin 6 and diethyl quinacridone (DEQ)(coumarin 6:DEQ=48:2) in 1000 parts by weight toluene. And, red color conversion layer formation ink was prepared by dissolving 50 parts by weight of a mixture of coumarin 6 and 4-dicyanomethylene-2-methyl-6-(julolidin-9-enyl)-4H-pyran (DCM-2) (coumarin 6:DCM-2=48:2) in 1000 parts by weight toluene.

The heated and dried color filter substrate was arranged in a multi-nozzle type inkjet apparatus (having an impact precision D_{CD} of approximately ±5 μm), installed in a nitrogen atmosphere containing 50 ppm or less oxygen and 50 ppm or less water. After alignment with markers, an ink dispensing head is scanned while dispensing green conversion layer formation ink, aiming at the centers of opening portions of the bank 50, equivalent to green subpixels. The operating conditions of the inkjet apparatus were adjusted, to cause the diameter D_{I} of ink liquid drops 70 during flight to be 30 μm, and three ink liquid drops were caused to impact in one green subpixel. After dispensing ink across the entire substrate, the color filter substrate was heated to 100° C. and dried without breaking the nitrogen atmosphere, to remove the solvent in the ink. The ink liquid drops 72 immediately after impact were in a state of bulging above the upper surface of the bank 50, as shown in FIG. 6B, but after heating and drying became a flat film as shown in FIG. 6C. Ink dispensing and heating and drying were repeated 10 times, to form a green color conversion layer 40G of film thickness approximately 0.5 μm. In this process, there was no flowing of the green color conversion layer formation ink into opening portions of the bank 50 equivalent to red subpixels, and color mixing between adjacent red and green subpixels was not observed.

Next, a similar procedure was repeated, except for using the red color conversion layer formation ink instead of the green color conversion layer formation ink, to form a red color conversion layer 40R of film thickness approximately 0.5 μm, and the color conversion filter substrate 1 shown in FIG. 4A and FIG. 43 was obtained.

Next, the organic EL emission substrate 2 and the color conversion filter substrate 1 were moved to a bonding apparatus installed in an environment with 5 ppm or less oxygen and 5 ppm or less water. And, the surface of the color conversion filter substrate on the side of the color conversion layers 40 was arranged facing upward. A dispenser was used to apply an epoxy system ultraviolet-hardening adhesive (XNR-5516, manufactured by Nagase ChemteX Corp.) to the periphery of each of the plurality of screens, to form peripheral seal material without discontinuities. Then, a mechanical measurement valve with a dispensing precision within 5% was used to drop lower-viscostiy thermosetting epoxy adhesive near the centers of each of the plurality of screens.

Next, the organic EL emission substrate 2 was arranged with the surface on the side of the barrier layer 180 facing downward, and pressure in the interior of the bonding apparatus was reduced to approximately 10 Pa or lower. The color conversion filter substrate 1 and the organic EL emission substrate 2 were moved close together in a state with both substrates parallel, and the entire perimeter of the peripheral seal material was brought into contact with the organic EL emission substrate 2. Here, positioning of both substrates was performed using an alignment mechanism; then the pressure within the bonding apparatus was returned to atmospheric pressure, and a slight load was applied so as to press against both substrates. At this time, while the thermosetting epoxy adhesive dropped near the screen center was spreading to the entirety of the peripheral seal material interior, the two substrates were moved still closer. The moving-closer of the two substrates was stopped when the tips of the spacers 80 of the color conversion filter substrate 1 came into contact with the barrier layer 180 of the organic EL emission substrate 2.

Next, only the peripheral seal material was irradiated with ultraviolet rays from the side of the color conversion filter substrate 1, causing temporary hardening of the peripheral seal material, and the bonded member was removed from the bonding apparatus. As a result of observation of the bonded member, the thermosetting epoxy adhesive extended over the entirety of the screens, and it was confirmed that there were no air bubbles within the screen and that there was no seepage of thermosetting epoxy adhesive from the peripheral seal material.

Then, using an automated glass scriber apparatus and a breaking apparatus, division into a plurality of screens was performed. The divided bonded members were heated for one hour at 80° C. in a heating furnace, causing hardening of the thermosetting epoxy adhesive, and the filler layer 190 was formed. Then, the bonded members were subjected to natural cooling for 30 minutes within the heating furnace. After removal from the heating furnace, the bonded members were arranged in a dry etching apparatus, and dry etching was performed to remove the barrier layer 180 at the peripheral portions of the bonded members, and terminal portions, IC connection pads and similar were exposed, to obtain organic EL displays.

### Practical Example 2

This practical example relates to an organic EL display having the structure of FIG. 8. First, the procedures of Practical Example 1 was repeated to form an organic EL emission substrate 2.

Next, a procedure similar to that of Practical Example 1 was used to form a black matrix 20, red color filter 30R and green color filter 30G on a transparent substrate 10, comprising 200×200 nm×0.7 nm thick alkali-free glass (Eagle 2000, manufactured by Corning Inc.). In this practical example, formation of a blue color filter 30B was omitted.

Next, Color Mosaic (a registered trademark) CB-7001 was diluted, and the dye concentration was reduced to prepare a blue material. Then, except for using this blue material in place of the photosensitive resin (CR-600, manufactured by Hitachi Chemical Co., Ltd.), the procedure of Practical Example 1 for formation of the bank 50 was employed to form a blue bank 50B. At this time, the applied film thickness of the blue material was approximately 5.5 μm. The blue bank 50B was a constituent element combining the functions of the bank 50 and the blue color filter 30B.

Next, a procedure similar to that of Practical Example 1 was used to form spacers 80, a green color conversion layer 40G, and a red color conversion layer 40R, and a color conversion filter substrate 1 was obtained. Also, a procedure similar to that of Practical Example 1 was used to perform bonding of the color conversion filter substrates 1 and organic EL emission substrates 2 and subsequent processes, and organic EL displays were obtained.

In this practical example, compared with Practical Example 1, by forming a blue bank 50B, the application process and patterning process to form a blue color filter 30B can be omitted.

### Practical Example 3

This practical example relates to an organic EL display with the structure of FIG. 9.

First, procedures similar to those of Practical Example 1 were used to form, on a transparent substrate 110 comprising 200×200 nm×0.7 nm thick alkali-free glass (AN-100, manufactured by Asahi Glass Co., Ltd.), constituent layers from the switching elements 120 to the transparent electrode 170.

Next, the layered member with the transparent electrode 170 formed was moved into a CVD apparatus without breaking the vacuum. A CVD method was used to form twice in alternation, on the entire substrate face, SiN of film thickness 0.5 μm and SiON of film thickness 0.5 μm, to form a barrier layer 180 of film thickness 2 μm.

Next, an ultraviolet-hardening resin, such as is used in microlens formation and similar, was diluted with a solvent, and a bank formation application liquid was prepared. Then, the bank formation application liquid was applied onto the barrier layer 180, and patterning was performed to form a bank 50 comprising a plurality of stripe-shape portions extending in the vertical direction. The bank 50 was formed from a plurality of stripe-shape portions on the barrier layer 180 on the boundary of green emission portions and red emission portions, and on the barrier layer 180 on blue emission portions. The stripe-shape portions formed on the boundary of the green emission portions and red emission portions had a width of approximately 10 μm, and the stripe-shape portions formed on the blue emission portions had a width of approximately 40 μm. The bank 50 had a film thickness of approximately 4 μm in the center portions of the blue emission portions. By means of the above processes, a bank 50 could be formed having opening portions of width 50 μm on the red emission portions and green emission portions, with a horizontal-direction dimension of 50 μm.

Next, except for the facts that formation was not on the color filters 30 of the color conversion filter substrate 1, but on the barrier layer 180 of the organic EL emission substrate, and that ink heating and drying were performed at approximately 90° C., procedures similar to those of Practical Example 1 were used to form a green color conversion layer 40G and a red color conversion layer 40R, and color-conversion organic EL emission substrates 4 were obtained.

Next, a procedure similar to that of Practical Example 1 was used to form a black matrix 20, red color filter 30R, green color filter 30G, and blue color filter 30B on a transparent substrate 10, comprising 200×200 nm×0.7 nm thick alkali-free glass (Eagle 2000, manufactured by Corning Inc.).

Next, on the boundary of two adjacent blue subpixels, a transparent photosensitive resin (CR-600, manufactured by Hitachi Chemical Co., Ltd.) was applied, and patterning performed, to form a plurality of spacers 60 on the blue color filter 30B positioned on the black matrix 20 on the boundary of two adjacent blue subpixels, and color filter substrates 3 were obtained. Each of the spacers 60 had a columnar shape with a diameter of approximately 15 μm and a height of approximately 2 μm. The color filter substrates 3 with spacers 60 formed were heated and dried.

Next, except for the facts that the color filter substrates 3 were used in place of the color conversion filter substrates 1, and that the color-conversion organic EL emission substrates 4 were used in place of the organic EL emission substrates 2, procedures similar to Practical Example 1 were used to perform bonding and subsequent processes, and organic EL displays were obtained.

Organic EL displays of this practical example had improved incidence efficiency emitted by the organic EL layer 160 on the color conversion layers 40, and improved rates of incidence of light on red subpixels and green subpixels compared with the displays of Practical Examples 1 and 2. This advantageous result is thought to be due to the fact that reflection at layer interfaces is suppressed due to the fact that low-refractive index layers (barrier layer 180, filler layer 190, and similar) do not exist between the organic EL layer 160 and the color conversion layers 40. Further, shortening of the distance between the organic EL layer 160 and the color conversion layers 40 is also thought to have contributed to the above-described improvement of the rate of incidence of light.

1. A flat panel display, comprising:
a color conversion filter substrate, including a transparent substrate, a black matrix which has a plurality of opening portions and which delimits red, green and blue subpixels, red and green color filters formed in the red and green subpixels, a bank, and red color conversion layers and green color conversion layers formed respectively in the red and green subpixels; and
an emission substrate having a plurality of light emission portions,
wherein the bank is formed from a blue-light transmissive material which transmits at least blue light, and has opening portions in the red subpixels and green subpixels,
wherein the red, green, and blue subpixels form pixels, each pixel having a blue subpixel side, and
wherein in every red and green subpixel on the flat panel display, the centers of opening portions of the bank are offset toward the blue subpixel side with respect to the centers of the opening portions of the black matrix.

2. The flat panel display according to claim 1, wherein, in each pixel, the bank is disposed on a portion of the black matrix positioned between the red subpixel and green subpixel, and on the blue subpixel.

3. The flat panel display according to claim 1, wherein the blue-light transmissive material blue material which transmits only blue light.

4. The flat panel display according to claim 1, further comprising a blue color filter in the blue subpixel of each pixel.

5. The flat panel display according to claim 1, wherein the emission substrate is an organic EL emission substrate.

6. A flat panel display, comprising:
an organic EL emission substrate, including a substrate, a reflective electrode, an insulating layer which has a plurality of opening portions, and which delimit a red emission portion, a green emission portion and a blue emission portion, an organic EL layer, a transparent electrode, a bank, a red color conversion layer formed at a position corresponding to a red subpixel, and a green color conversion layer formed at a position corresponding to a green subpixel; and
a color filter substrate, including a transparent substrate, and red and green color filters;
wherein the bank is formed from a blue-light transmissive material which transmits at least blue light, and has opening portions in the red emission portion and green emission portion; and
wherein in the red emission portion and green emission portion, the centers of opening portions of the bank are offset toward a blue emission portion side with respect to the centers of the opening portions of the insulating layer.

7. The flat panel display according to claim 6, wherein the bank is formed on a boundary between the red emission portion and green emission portion, and on the blue emission portion.

8. The flat panel display according to claim 6, wherein the blue-light transmissive material forming the bank is a blue material which transmits only blue light.

9. The flat panel display according to claim 6, further comprising a blue color filter in the color filter substrate.

10. A method of manufacturing a flat panel display, comprising the steps of:
(1) forming a color conversion filter substrate, including:
(a) forming a black matrix having a plurality of opening portions on a transparent substrate, and delimiting red, green, and blue subpixels by the plurality of opening portions;
(b) forming red and green color filters in the red and green subpixels respectively;
(c) using a blue-light transmissive material which transmits at least blue light to form a bank having opening portions at the red subpixels and green subpixels, wherein in every red and green subpixel on the color conversion filter substrate, the centers of opening portions of the bank are offset toward a blue subpixel side with respect to the centers of the opening portions of the black matrix; and
(d) using an inkjet method to form red color conversion layers and a green color conversion layers in the red and green subpixels;
(2) preparing an emission substrate having a plurality of emission portions; and
(3) bonding together the color conversion filter substrate and the emission substrate.

11. The method of manufacturing a flat panel display according to claim 10, wherein, in step (1)(c), the bank is formed on the black matrix positioned on boundaries between the red subpixels and green subpixels, and on the blue subpixels.

12. The method of manufacturing a flat panel display according to claim 10, wherein the blue-light transmissive material forming the bank is a blue material which transmits only blue light.

13. The method of manufacturing a flat panel display according to claim 10, further comprising a step (b′) of forming blue color filters in the blue subpixels.

14. The method of manufacturing a flat panel display according to claim 10, wherein the emission substrate is an organic EL emission substrate.

15. A method of manufacturing a flat panel display, comprising the steps of:
(1) forming an organic EL emission substrate, including the steps of:
(a) forming a reflective electrode on a substrate;
(b) forming an insulating layer having a plurality of opening portions, and delimiting a red emission portion, a green emission portion, and a blue emission portion by the plurality of opening portions;
(c) forming an organic EL layer;
(d) forming a transparent electrode;
(e) using a blue-light transmissive material which transmits at least blue light to form a bank having opening portions in the red emission portion and green emission portion, wherein in the red and green emission portions, the centers of opening portions of the bank are offset toward a blue emission portion side with respect to the centers of the opening portions of the insulating layer; and
(f) using an inkjet method to form a red color conversion layer and a green color conversion layer in the red emission portion and in the green emission portion respectively;
(2) forming red and green color filters on a transparent substrate, and forming a color filter substrate; and
(3) bonding together the organic EL emission substrate and the color filter substrate.

16. The method of manufacturing a flat panel display according to claim 15, wherein, in the step (1)(e), the bank is formed on a boundary between the red emission portion and green emission portion, and on the blue emission portion.

17. The method of manufacturing a flat panel display according to claim 15, wherein the blue-light transmissive material forming the bank is a blue material which transmits only blue light.

18. The method of manufacturing a flat panel display according to claim 15, further comprising forming a blue color filter on the transparent substrate.

19. A color conversion filter substrate, comprising:
a transparent substrate;
a black matrix which has a plurality of opening portions and which delimits red, green and blue subpixels;
red and green color filters formed in the red and green subpixels;
a bank; and
red color conversion layers and green color conversion layers formed respectively in the red and green subpixels,
wherein the bank is formed from a blue-light transmissive material which transmits at least blue light, and has opening portions in the red subpixel and green subpixel,
wherein the red, green, and blue subpixels form pixels, each pixel having a blue subpixel side, and
wherein in every red and green subpixel on the color conversion filter substrate, the centers of opening portions of the bank are offset toward the blue subpixel side with respect to the centers of the opening portions of the black matrix.

20. The color conversion filter substrate according to claim 19, wherein, in each pixel, the bank is disposed on a portion of the black matrix positioned between the red subpixel and green subpixel, and on the blue subpixel.

21. The color conversion filter substrate according to claim 19, wherein the blue-light transmissive material forming the bank is a blue material which transmits only blue light.

22. The color conversion filter substrate according to claim 19, further comprising blue color filters in the blue subpixels.

23. An organic EL emission substrate, comprising:
a substrate;
a reflective electrode;
an insulating layer which has a plurality of opening portions and which delimit a red emission portion, a green emission portion and a blue emission portion;
an organic EL layer;
a transparent electrode;
a bank; and
a red color conversion layer, and a green color conversion layer;
wherein the bank is formed from a blue-light transmissive material which transmits at least blue light, and has opening portions in the red emission portion and green emission portion, and
wherein in the red emission portion and green emission portion, the centers of opening portions of the banks are offset toward a blue emission portion side with respect to the centers of the opening portions of the insulating layer.

24. The organic EL emission substrate according to claim 23, wherein the bank is formed on a boundary between the red emission portion and green emission portion, and on the blue emission portion.

25. The organic EL emission substrate according to claim 23, wherein the blue-light transmissive material forming the bank is a blue material which transmits only blue light.
